(19) United States
(12) Patent Application Publication
(10) Pub. No.: US 2006/0227353 A1
(43) Pub. Date: Oct. 12, 2006

(54) Printing apparatus and program thereof

(76) Inventor: Hiroshi Morikawa, Osaka (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/521,355

(22) PCT Filed: Oct. 3, 2003
(86) PCT No.: PCT/JP03/12746

§ 371 Date: Feb. 7, 2006

(51) Int. Cl. G06F 3/12

(52) U.S. Cl. 358/1.13; 358/3.27

(57) ABSTRACT

The invention provides a printing apparatus including a bitmap data storage unit for storing bitmap data, a bitmap data acquisition unit for acquiring bitmap data therefrom, a jaggy elimination processing unit for eliminating jaggies on the bitmap data acquired, and a printing unit for printing data that is produced based on processing results from the jaggy elimination processing unit. Thereby, bitmap data can be rendered naturally without reducing its actual size.

### BACKGROUND OF THE INVENTION

1. Field of the Invention

This invention relates to apparatuses and others for printing bitmap data.

2. Description of Related Art

When using a conventional printing appratus, a bitmapped graphic that is inherently affected by resolution was rendered rather small. This was the most common problem arising when avoiding jagged edges appearing on the outline of a picture by increasing resolution. If that graphic is printed out without reducing its size, an output can have its native resolution only to reveal a rouch appearance.

Specifically, when printing a 50 dpi (dots per inch) bitmapped graphic having the size of 100×70 pixels, as shown in FIG. 4, without resizing, a resulting picture will look jagged. If the resolution is increased up to 100 dpi, the image size becomes as small as 50×35 pixels as shown in FIG. 25. This clarifies that using the conventional printing techniques, the stepping effect called “jaggy” could not be avoided on a produced picture without sacrificing its size.

### SUMMARY OF THE INVENTION

A printing apparatus of the present invention includes: a bitmap data storage unit for storing bitmap data; a bitmap data acquisition unit for acquiring the bitmap data from the bitmap data storage unit; a jaggy elimination processing unit for executing processing of eliminating jaggies on the bitmap data; and a printing unit for printing data that is produced based on processing results from the jaggy elimination processing unit.

This arrangement brings bitmap data into a jaggy-less image without sacrificing its size (i.e., its image quality) when printed.

In the above printing apparatus, the jaggy elimination processing unit includes: a jaggy detection unit for detecting jaggies appearing on the bitmap data; and a vector data production unit for producing vector data, based on all stair-like straight lines on jaggies that were detected by the jaggy detection unit, by drawing a straight line from the midpoint of one straight line to the midpoint of another straight line adjacent thereto.

This arrangement brings bitmap data into a more smoothed image when printed.

Furthermore, the above printing apparatus includes: a transformation rule retention unit for retaining bitmap data transformation rules; and a data transformation unit for transforming part of the bitmap data according to the rules, and the printing unit prints data that is produced based on transformation results from the data transformation unit and processing results from the jaggy elimination processing unit.

This arrangement brings bitmap data into an even more sleek appearance when printed.

### BRIEF DESCRIPTION OF ACCOMPANYING DRAWINGS

FIG. 1 is a block diagram illustrating a printing apparatus in accordance with a first embodiment of the present invention.

FIG. 2 is a flowchart depicting operations of the printing apparatus in accordance with the first embodiment of the present invention.

FIG. 3 is a flowchart depicting jaggy elimination processing in accordance with the first embodiment of the present invention.

FIG. 4 presents an example of ‘jagged’ bitmap data that will be printed out in accordance with the first embodiment of the present invention.

FIG. 5 presents an enlarged view of a jaggy taken from FIG. 4 in accordance with the first embodiment of the present invention.

FIG. 6 illustrates how the jaggy in FIG. 5 is eliminated in accordance with the first embodiment of the present invention.

FIG. 7 illustrates an overall picture obtained when the jaggy elimination processing shown in FIG. 6 is repeatedly performed on relevant portions within the bitmap data shown in FIG. 4 in accordance with the first embodiment of the present invention.

FIG. 8 presents a printing example of the bitmap data in FIG. 4 in accordance with the first embodiment of the present invention.

FIG. 9 presents an example of vector data in accordance with the first embodiment of the present invention.

FIG. 10 is a block diagram illustrating a printing apparatus in accordance with a second embodiment of the present invention.

FIG. 11 is a flowchart depicting operations of the printing apparatus in accordance with the second embodiment of the present invention.

FIG. 12 is a flowchart depicting a particular operation of data transformation in accordance with the second embodiment of the present invention.

FIG. 13 is a data transformation rule management table, into which data transformation rules in accordance with the second embodiment of the present invention are tabulated.

FIG. 14 presents an example of ‘jagged’ bitmap data in accordance with the second embodiment of the present invention.

FIG. 15 presents an example of applying the data transformation rules in accordance with the second embodiment of the present invention.

FIG. 16 presents an example of bitmap data that underwent the data transformation in accordance with the second embodiment of the present invention.

FIG. 17 is a block diagram of a printing apparatus in accordance with the third embodiment of the present invention.

FIG. 18 shows, apart from FIG. 13, another variation of data transformation rules in accordance with the third embodiment of the present invention.

FIG. 19 shows original data before transformation in accordance with the third embodiment of the present invention.

FIG. 20 shows data to which the data transformation rules were applied during transformation in accordance with the third embodiment of the present invention.

FIG. 21 shows data to which the data transformation rules were not applied during transformation in accordance with the third embodiment of the present invention.

FIG. 22 presents an example of bitmap data before transformation in accordance with the first embodiment of the present invention.

FIG. 23 presents an example of bitmap data after transformation in accordance with the first embodiment of the present invention.

FIG. 24 presents an explanatory image on how the transformation takes place in accordance with the first embodiment of the present invention.

FIG. 25 presents a printing example of bitmap data in accordance with a prior art.

### DETAILED DESCRIPTION OF THE PREFERRED EMBODIMENTS

Preferred embodiments of a printing apparatus of the present invention will be discussed hereinafter, making reference to the accompanying drawings. Here note that the same reference numerals are used throughout the drawings and the description in order to refer to the same or similar constituent elements in terms of their behavior or function, and descriptions thereof will not be repeated.

### Embodiment 1

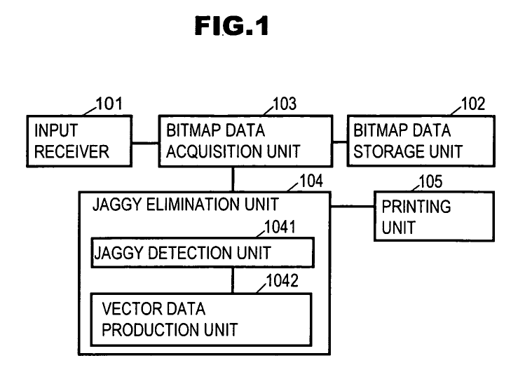

Referring to FIG. 1, a block diagram illustrating a printing apparatus in accordance with a first embodiment of the present invention is shown. This apparatus includes an input receiver 101, a bitmap data storage unit 102, a bitmap data acquisition unit 103, a jaggy elimination processing unit 104, and a printing unit 105. The jaggy elimination processing unit 104 includes a jaggy detection unit 1041 and a vector data production unit 1042.

The input receiver 101 receives a printing request command that specifies printing of bitmap data. This command generally contains a data identifier that identifies which bitmap data to be printed out. In order for a user to enter this command, any kind of input means may be feasible, let alone the use of a keyboard or a mouse, or by selecting from a menu screen. The input receiver 101 can be realized by using a device driver that is usually provided together with a keyboard or a mouse, or control software that enables selection from a menu screen.

The bitmap data storage unit 102 stores bitmap data, whose format is irrelevant in this case, and any kind of raster data including Microsoft(TM) Bitmap is acceptable. For the storage unit 102, it is preferable to employ a nonvolatile memory device. However, an alternative volatile type is also feasible.

In response to the request command received by the input receiver 101, the bitmap data acquisition unit 103 reads out bitmap data from the bitmap data storage unit 102. Typically, the data acquisition unit 103 can be formed by using an MPU, a memory, and the like, and all processes assigned thereto are realized by software that is stored in a recording medium such as a ROM. However, hardware implementation (using a dedicated circuit) is also feasible.

The jaggy elimination processing unit 104 eliminates jaggies appearing on the bitmap data that was acquired by the bitmap data acquisition unit 103. In order to eliminate jaggies, any method can be employed. The kind of algorithm that works will be discussed in detail below. Typically, the jaggy elimination processing unit 104 can be formed by using an MPU, a memory, and the like, and all processes assigned thereto are realized by software that is stored in a recording medium such as a ROM. However, hardware implementation (using a dedicated circuit) is also feasible.

After the jaggies appearing on the relevant data were successfully smoothed out, the printing unit 105 then puts that data into print. The printing unit 105 includes, for example, a printer and its driver software, or may be considered software that enables a printing request command to be sent to an external printer.

The jaggy detection unit 1041 detects jaggies appearing on the bitmap data that was acquired by the bitmap data acquisition unit 103. The jaggy detection is carried out through the following steps: The jaggy detection unit 1041 checks whether there is a jaggy for all positions of graphical components within the bitmap data in either a horizontal or vertical direction. The jaggy detection unit 1041 detects multiple straight lines, and obtains a starting point and an end point for each line. If a straight line and its neighboring straight line form a stairstep whose height exceeds a predetermined value, the jaggy detection unit 1041 judges that portion is a ‘jaggy.’ Here the “predetermined value” would mean “two dots or more” or “10 dots or more,” for example.

The vector data production unit 1042 produces vector data, based on all stair-like straight lines on the jaggies that were detected by the jaggy detection unit 1041, by drawing a straight line from an approximate midpoint of one straight line to an approximate midpoint of another straight line adjacent thereto. Here the interconnecting point is preferably the median. However, any two points that make a smooth appearance to user's eye are feasible. The vector data includes, for example, coordinate values representing a starting point and an end point of each straight line. The jaggy detection unit 1041 and the vector data production unit 1042 can typically be formed by using an MPU, a memory, and the like, and all processes assigned thereto are realized by software that is stored in a recording medium such as a ROM. However, hardware implementation (using a dedicated circuit) is also feasible.

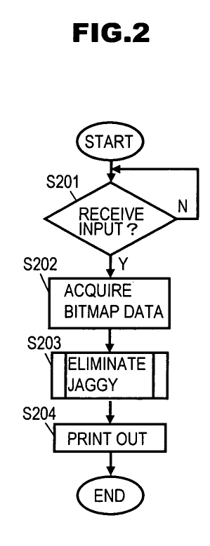

Operations of the printing apparatus in the first embodiment will be discussed hereinafter by referring to the flowchart shown in FIG. 2.

In step S201, the input receiver 101 checks whether or not a printing request command is received. If the reception is confirmed, it proceeds to step S202; otherwise, it returns to step S201.

In step S202, according to the command received, the bitmap data acquisition unit 103 reads out bitmap data from the bitmap data storage unit 102.

In step S203, the jaggy elimination processing unit 104 commences elimination of jaggies from the bitmap data acquired in step S202. Then following the jaggy elimination, smoothed data is outputted. How jaggies are smoothed out will be discussed in detail below.

In step S204, the printing unit 105 prints the data that underwent the jaggy elimination processing during step S203, and terminates the ongoing process.

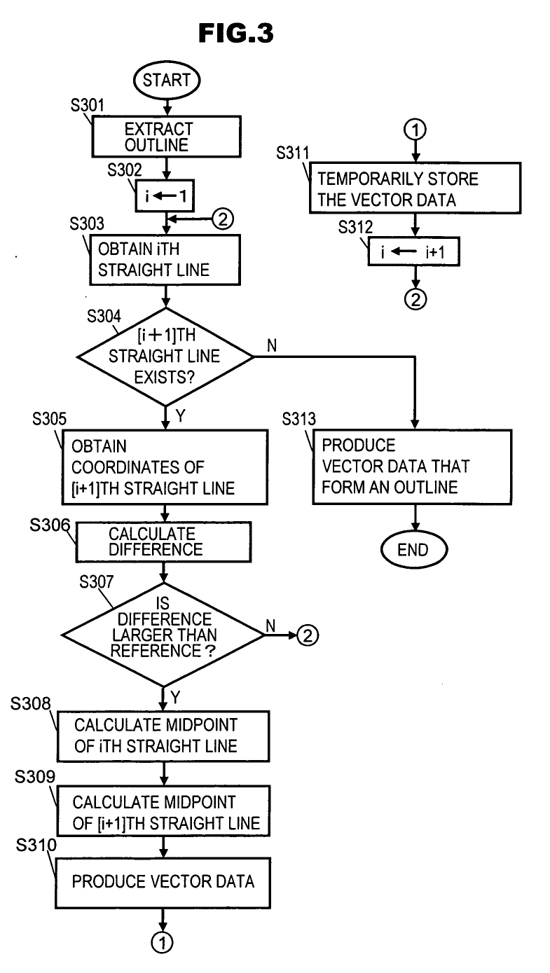

Next, how jaggy elimination is carried out will be discussed by referring to the flowchart shown in FIG. 3.

In step S301, the jaggy detection unit 1041 extracts the outline of bitmap data. Then multiple straight lines that form that outline are outputted in the form of coordinates representing a starting point and an end point (e.g., x1, y1, x2, y2). (x1, y1) represent a starting point of the ith straight line, while (x2, y2) an end point thereof.

In step S302, the jaggy detection unit 1041 enters 1 (one) to a counter i.

In step S303, the jaggy detection unit 1041 obtains coordinates of the ith straight line (x1, y1, x2, y2) among other lines.

In step S304, the jaggy detection unit 1041 checks on the multiple coordinate sets that were outputted in step S301 whether or not the coordinates of the [i+1]th straight line exist. If the relevant coordinates exist, it proceeds to step S305; otherwise, it jumps to step S313.

In step S305, the jaggy detection unit 1041 obtains the coordinates of the [i+1]th straight line (x3, y3, x4, y4). (x3, y3) represent a starting point, while (x4, y4) an end point.

In step S306, the jaggy detection unit 1041 obtains the height of a stairstep composed of two straight lines, using their coordinates (x2, y2) and (x3, y3). The height of a step is in other words a distance between the two sets of coordinates.

In step S307, the jaggy detection unit 1041 then checks on the height obtained in step S306 whether or not it exceeds a predetermined value. If it exceeds the predetermined value, the ongoing process proceeds to step S308; otherwise, it returns to step S303. Here the predetermined value may be assigned two or larger. In this manner, ‘jaggy or not’ judgment is made.

In step S308, the vector data production unit 1042 calculates the midpoint of the ith straight line following the formula {(x1+x2)/2, (y1+y2)/2}.

In step S309, the vector data production unit 1042 calculates the midpoint of the [i+1]th straight line following the formula {(x3+x4)/2, (y3+y4)/2}.

In step S310, the vector data production unit 1042 produces vector data from the calculation results obtained through steps S308 and S309. The resulting vector data becomes {(x1+x2)/2, (y1+y2)/2, (x3+x4)/2, (y3+y4)/2}.

In step S311, the vector data production unit 1042 temporarily stores the vector data produced in step S310.

In step S312, after incrementing the counter i by one, the ongoing process returns to step S303.

In step S313, the vector data production unit 1042 produces vector data that will form the smoothed version of an outline, from the multiple coordinate sets of straight lines that form the jagged outline of the bitmap data and were outputted in step S301, plus at least one set of vector data temporarily stored in step S311. Specifically, among the coordinate values outputted in step S301, those judged ‘non-jaggy’ as well as temporarily-stored vector data in step S311 are sourced into new vector data that will supersede the jagged outline of the bitmapped graphic. The vector data completed thereby forms a ‘jaggy-less’ outline portion. A detailed description on this vector data will be provided below. When the vector data is completed, the ongoing process terminates.

In order to succeed in eliminating jaggies, any method other than the one depicted in FIG. 3 is also feasible for step S203. For example, investigating all dots composing a graphical image can be proposed as an alternative method. Where an image is composed of a horizontal dots (along the x-axis) by b vertical dots (along the y-axis), the y-axis is moved from 0 to b-1, and for each y-axis value, the x-axis is scanned from 0 to a-1. This sequence can be described using a programming language such as the C language: for (y=0; y<b ; y++) {for (x<a+x++) {Scan ( );}}, where a double loop is created so as to repeatedly execute the function Scan for all dots. The function Scan checks whether or not a relevant position is on a jagged stairs. After executing Scan, when the jaggy position is confirmed, new information based on the x- and y-axes is added onto the vector data storage unit. When doing so, the judgment on ‘jaggy’ or ‘nonjaggy’ is made with reference to the brightness of a dot. This reference brightness can be obtained by taking the RGB properties composing one dot into account and using the formula {brightness=B+R*2+G*4}, where B, R, and G represent blue, red, and green, respectively. Then if the excessive brightness continues in either a horizontal or vertical direction, that portion is judged ‘jaggy.’ The length for which this phenomenon continues equals to the length of a jaggy. If a jaggy has a one-dot length, it forms a stairs slanting at 45 degrees. If a jaggy is as long as 100 dots, it forms a gentle slope.

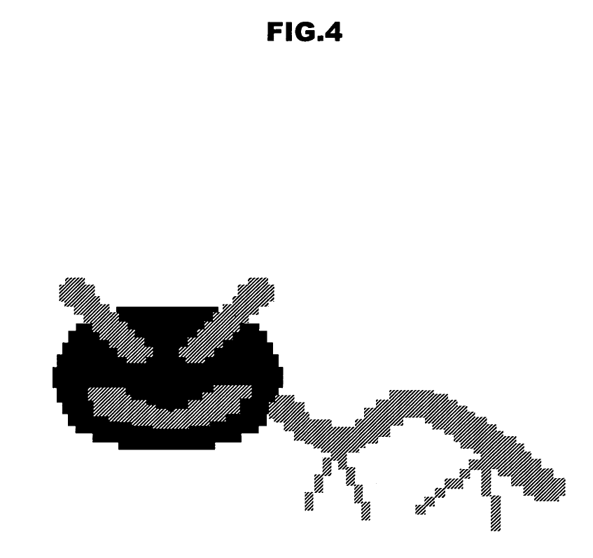

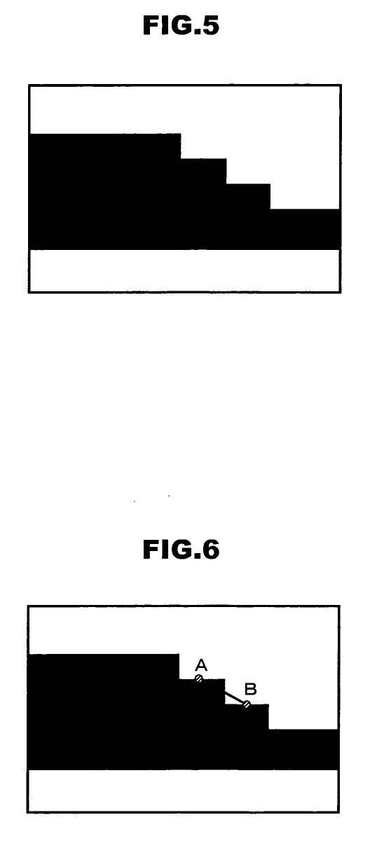

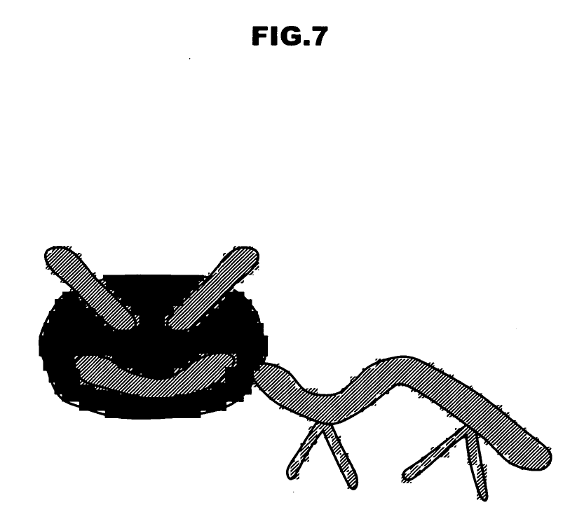

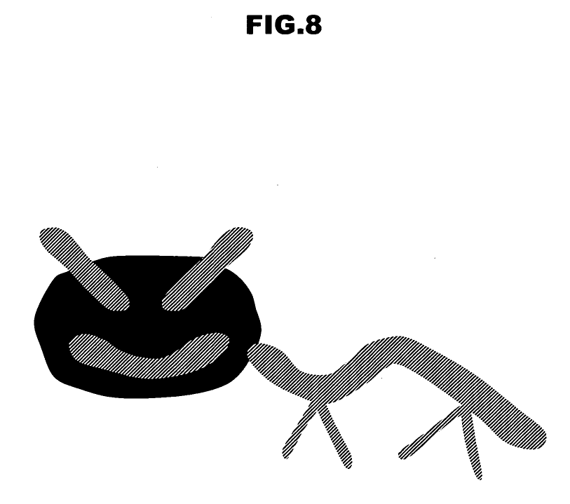

The operations of the printing apparatus in the first embodiment will be discussed hereinafter in detail. FIG. 4 shows bitmap data to be printed, and jaggies (a stair-like portion) appearing on that data are shown enlarged in FIG. 5. Suppose that the printing apparatus has received from a user a printing request that specifies the bitmap data in FIG. 4 to be printed. Subsequent to this reception, the apparatus reads out the relevant bitmap data, and then detects jaggies in FIG. 5. After that, coordinate values are outputted representing a straight line by which two straight lines that form a stairstep larger than the predetermined value are interconnected at each midpoint (point A and point B). This compensation line starts at point A and ends at point B. Likewise, interconnecting two straight lines is repeated on the whole outline portion of the bitmap data, and thereby, as shown in FIG. 7, smoothed data, a bunch of sleek lines is obtained. Then, the printing apparatus prints the data as shown in FIG. 8.

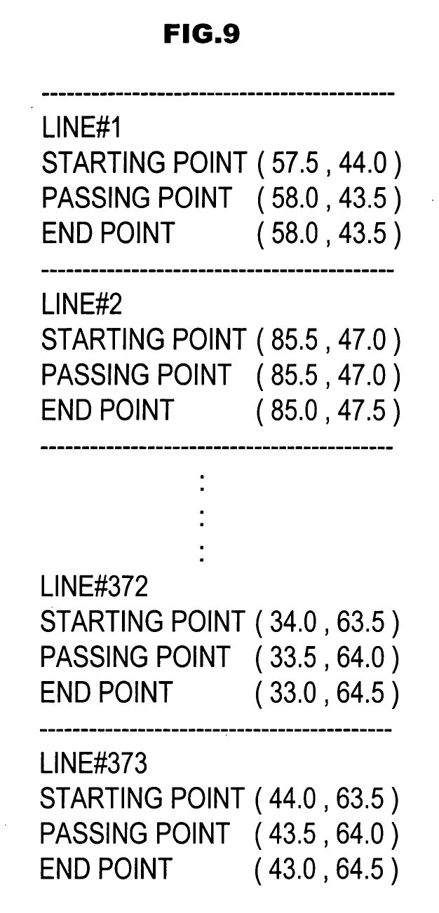

What is utilized in the printing of a smoothed graphic as shown in FIG. 8 is vector data. FIG. 9 shows the one composed of 373 lines, each having a starting point, a passing point, and an end point. Those values inside the parentheses are coordinate (x- and y-axes) values. Using such vector data, smoothed appearance can be realized in output.

Thus, in accordance with the first embodiment of the present invention, bitmap data from which jaggies were removed can be printed out without sacrificing its actual size.

It is needless to say that the kind of contents is irrelevant for the bitmap data in the first embodiment. However, the effectiveness yielded by the first embodiment will be maximized when handling the results of fluid or gas analysis. A flow of fluid or gas can be visualized accurately without interruption, which makes it easier for a user to explore analysis results, and therefore increases the credibility of the analysis results per se.

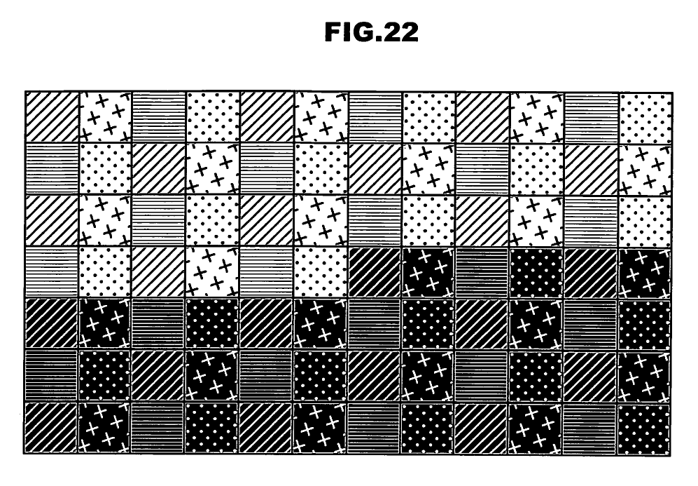

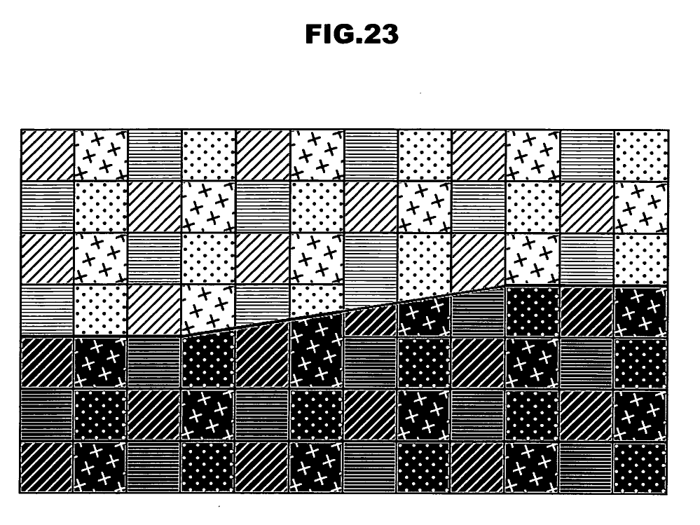

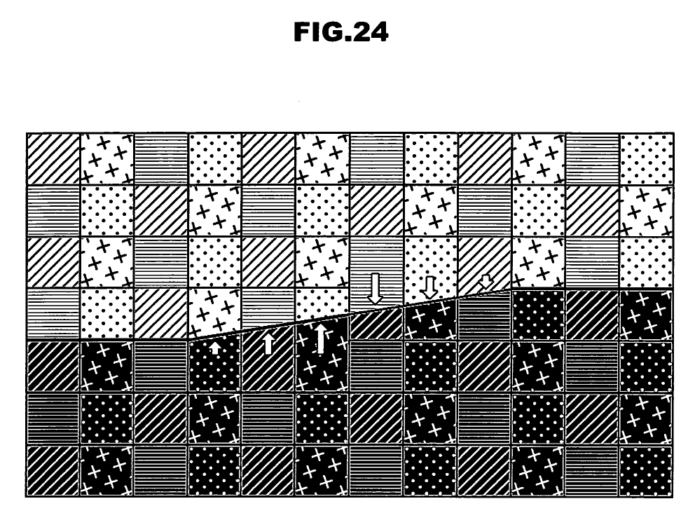

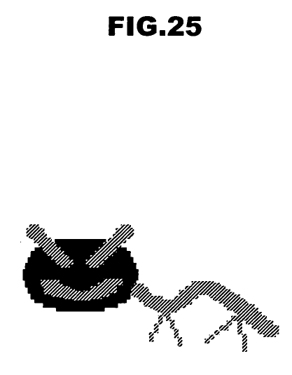

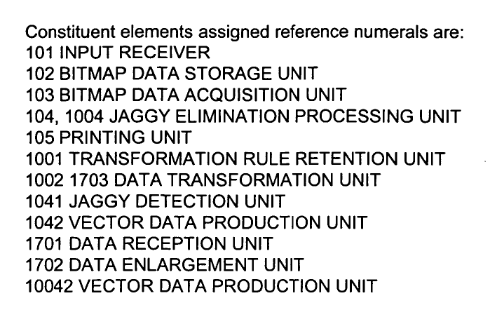

Furthermore, for an image data type, either binary or color is acceptable in the first embodiment. In the case of eliminating rough edges on a color graphic, it is preferable to use a closest color following the processes depicted in FIGS. 22 through 24. Referring first to FIG. 22, ‘jagged’ color bitmap data is shown. As mentioned above, the data is checked (scanned) while shifting by one dot at a time so as to obtain the brightness of each dot. Then if the brightness is continuously excessive for multiple dots in either a horizontal or vertical direction, that portion is judged a ‘jagged’ stairstep. In the particular example of FIG. 22, a data processing device judges there is a jaggy around the center of the data. Then, as shown in FIG. 23, closest colors (on either upper side or lower side) are imparted to relevant dots so as to fade a sheer surface as if rubbing the corner. The arrows shown in FIG. 24 represent either upper-side or lower-side color is properly determined for each dot. Note that small rectangles shown in FIGS. 22 through 24 are composed of multiple dots, and this feature applies to any embodiments other than this.

The operations set forth in the first embodiment may be realized by software. Such software may be distributed on the Internet by means of downloading, or may be circulated in a recording medium such as a CD-ROM. This feature also applies to any embodiments other than this. Here note that software capable of realizing the operations of the printing apparatus as discussed in the first embodiment is a computer program that enables a computer to execute the steps of: acquiring bitmap data stored thereon; eliminating jaggies appearing on the bitmap data; and specifying printing of data that is produced based on processing results in the jaggy elimination step.

### Embodiment 2

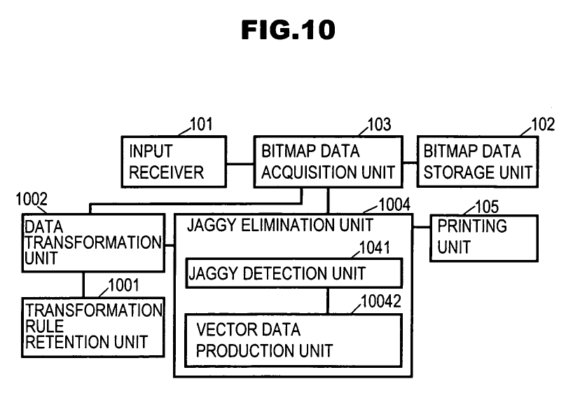

Referring to FIG. 10, a block diagram illustrating a printing apparatus in accordance with a second embodiment of the present invention is shown. This apparatus includes: an input receiver 101; a bitmap data storage unit 102; a bitmap data acquisition unit 103; a transformation rule retention unit 1001; a data transformation unit 1002; a jaggy elimination processing unit 1004, and a printing unit 105. The jaggy elimination processing unit 1004 includes a jaggy detection unit 1041 and a vector data production unit 10042.

The rule retention unit 1001 retains data transformation rules according to which bitmap data is transformed. Data configuration of the rules is irrelevant. A detailed description on them will be provided below. For the rule retention unit 1001, it is preferable to employ a nonvolatile memory device. However, an alternative volatile type is also feasible.

According to the transformation rules in the rule retention unit 1001, the data transformation unit 1002 transforms part of the bitmap data. Typically, the data transformation unit 1002 can be formed by using an MPU, a memory, and the like, and all processes assigned thereto are realized by software that is stored in a recording medium such as a ROM. However, hardware implementation (using a dedicated circuit) is also feasible.

The jaggy elimination processing unit 1004 eliminates jaggies appearing on the data portions other than the data transformed by the data transformation unit 1002. This means that the transformation process by the transformation unit 1002 precedes the jaggy elimination process. Typically, the jaggy elimination processing unit 1004 can be formed by using an MPU, a memory, and the like, and all processes assigned thereto are realized by software that is stored in a recording medium such as ROM. However, hardware implementation (using a dedicated circuit) is also feasible.

While giving highest priority to the transformation results, the vector data production unit 10042 produces vector data, based on all stair-like straight lines on the jaggies that were detected by the jaggy detection unit 1041, by drawing a straight line from an approximate midpoint of one straight line to an approximate midpoint of another straight line adjacent thereto.

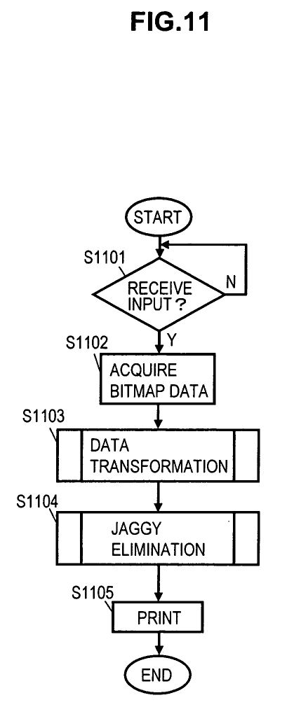

Operations of the printing apparatus in the second embodiment will be discussed hereinafter by referring to the flowchart in FIG. 11.

In step S1101, the input receiver 101 checks whether or not a printing request command is received. If the reception is confirmed, it proceeds to step S1102; otherwise, it returns to step S1101.

In step S1102, according to the request command received, the bitmap data acquisition unit 103 reads out bitmap data from the bitmap data storage unit 102.

In step S1103, according to the transformation rules retained in the rule retention unit 1001, the data transformation unit 1002 transforms part of the bitmap data acquired in step S1102. Regarding the transformation process, a detailed description will be provided below.

In step S1104, the jaggy elimination processing unit 104 eliminates jaggies appearing on the bitmap data that underwent the transformation during step S1103. When the jaggy elimination is completed, smoothed data is outputted. A detailed description will be provided below.

In step S1105, the printing unit 105 prints the smoothed data, and terminates the ongoing process.

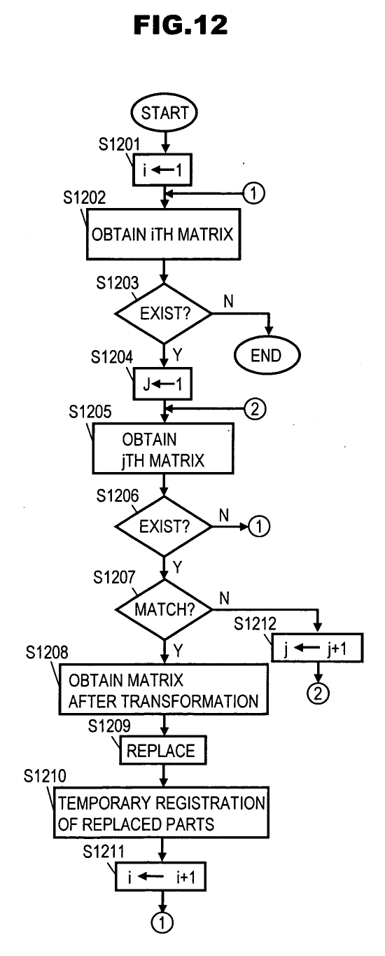

Now, how data transformation takes place during step S1103 will be discussed by referring to the flowchart in FIG. 12.

In step S1201, the data transformation unit 1002 enters 1 (one) to a counter i.

In step S1202, the data transformation unit 1002 obtains the ith matrix from the bitmap data. The matrix is a dot pattern of n×m (n and m represent any integer), and a 3×3 dot pattern is preferable when considering the fact that the application of a transformation rule has been proved useful in many scenarios. Generally, when i is 1, the n×m matrix is obtained from the upper left corner of the bitmap data. Likewise, when i is 2, the matrix is obtained by shifting to right by one dot.

In step S1203, the data transformation unit 1002 checks whether or not the ith matrix was successfully obtained in step S1202. If the relevant matrix is confirmed, it proceeds to step S1204; otherwise, the ongoing process terminates.

In step S1204, the data transformation unit 1002 enters 1 (one) to a counter j.

In step S1205, the transformation unit 1002 obtains a jth matrix before transformation from the rule retention unit 1001. Note that what the rule retention unit 1001 retains is a correspondence table between a matrix before transformation and a matrix after transformation. An example of this will be provided below.

In step S1206, the transformation unit 1002 checks whether or not the jth matrix before transformation exists (i.e., it checks whether or not the jth rule exists). If the relevant matrix is confirmed, it proceeds to step S1207; otherwise, it returns to step S1202.

In step S1207, the transformation unit 1002 checks whether or not the ith matrix obtained in step S1202 matches the jth matrix before transformation obtained in step S1205. If the matching is confirmed, it proceeds to step S1208; otherwise, it jumps to step S1212.

In step S1208, the transformation unit 1002 obtains the jth matrix after transformation from the rule retention unit 1001.

In step S1209, the transformation unit 1002 replaces the ith matrix with the jth matrix.

In step S1210, the transformation unit 1002 temporarily registers parts of the bitmap data that were replaced during step S1209. Those replaced parts are specified using data indicating the coordinates of a relative position within the bitmap data.

In step S1211, after incrementing the counter i by one, the process returns to step S1202.

In step S1212, after incrementing the counter j by one, the process returns to step S1205.

Now, the jaggy elimination taking place during step S1104 will be discussed. Basically, the jaggy elimination processing is the same as the one set forth in the first embodiment, except for one thing: During step S1104, the elimination process is not performed on the particular portions that have been temporarily registered since step S1210, where the transformation rules applied.

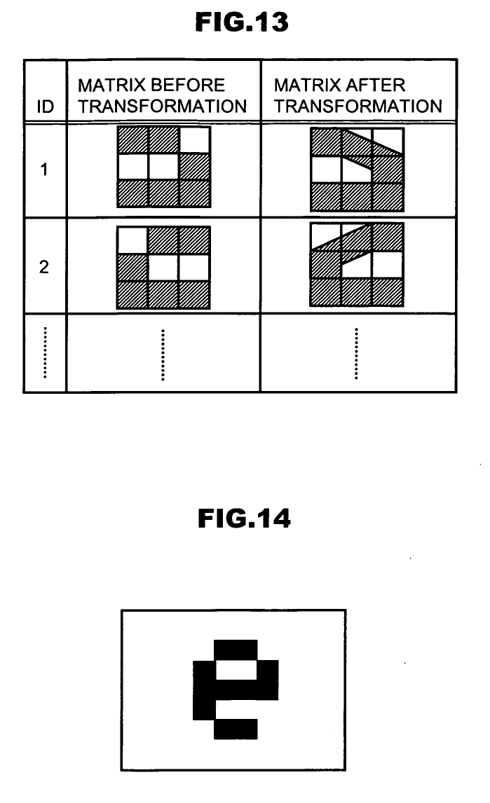

The operations of the printing apparatus in the second embodiment will be discussed hereinafter in detail. FIG. 13 is a data transformation rule management table retained by the rule retention unit 1001. The table is composed of at least one record that contains data under the headings “ID,” “Matrix Before Transformation,” and “Matrix After Transformation.” “ID” is a piece of information uniquely assigned to each record, and is useful in multiple tables management. Both “Matrix Before Transformation” and “Matrix After Transformation” columns contain attribute values. The following will describe how these elements work as a rule. When looking into the contour of a bitmapped graphic, if a pattern that matches any one of the matrices appearing under “Matrix Before Transformation” is found, that pattern is to be replaced with a corresponding matrix appearing under “Matrix After Transformation.”

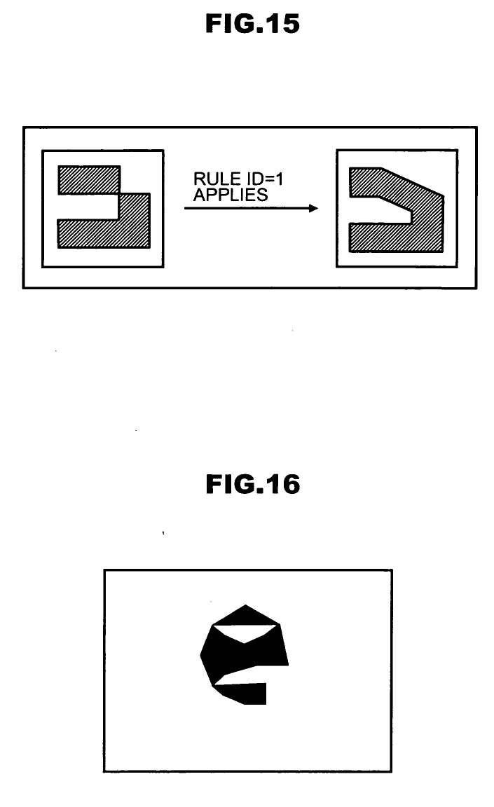

For example, in the case of transforming ‘jagged’ bitmap data “e” in FIG. 14, a data transformation rule whose ID is 1 in FIG. 13 applies as shown in FIG. 15. Following the transformation repeatedly performed, the jaggy elimination set forth in the first embodiment comes next, so that a disedged round “e” that is comfortable to the eye can be obtained in output. Note that in the second embodiment, if the transformation as set forth above is not performed but the jaggy elimination process is carried out (i.e., if only the processing set forth in the first embodiment is performed), the bitmap data “e” in FIG. 14 becomes the one in FIG. 16, which is odd.

As clarified above, in accordance with the second embodiment, bitmap data can be printed out as a jaggy-less image without changing its actual size. Moreover, adopting certain transformation rules enables graphics to be properly tuned to a user's preference and to be rendered realistically.

Although what is shown in FIG. 13 is proposed as the transformation rules in the second embodiment, other variations are also feasible. However, even when using the other kinds of rules, it is still preferable that based on 3×3 dot patterns before transformation and 3×3 dot patterns after transformation, dot patterns that match any one of those before transformation should be replaced with their corresponding patterns after transformation.

The operations set forth in the second embodiment may be realized by software. Such software may be distributed on the Internet by means of downloading, or may be circulated in a recording medium such as a CD-ROM. This feature also applies to any embodiment other than this. Here note that software capable of realizing the operations of the printing apparatus as discussed in the second embodiment is a computer program that enables a computer to execute the steps of: acquiring bitmap data stored thereon; transforming part of the bitmap data according to data transformation rules stored thereon; eliminating jaggies appearing on the bitmap data that underwent the transformation during the data transformation step; and specifying printing of data that is produced based on processing results in the jaggy elimination step.

### Embodiment 3

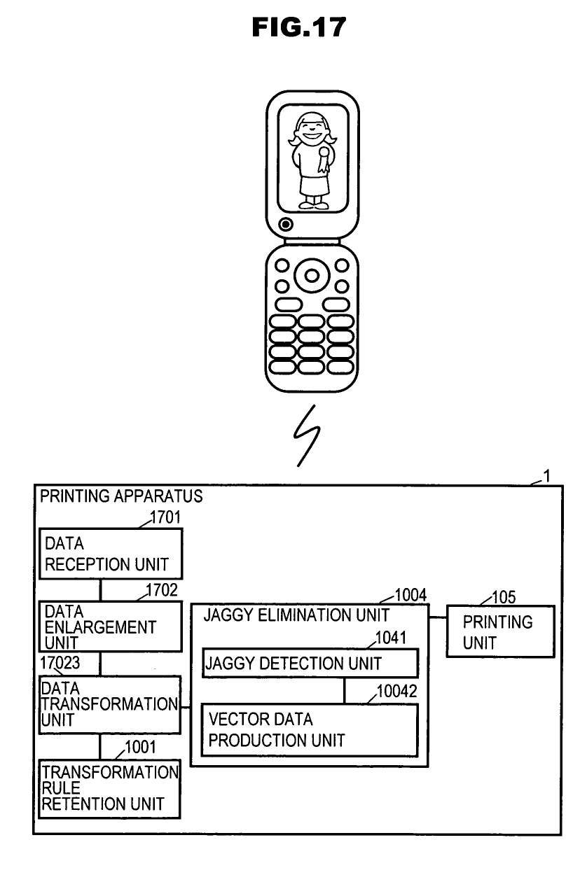

In a third embodiment, a printing apparatus capable of receiving data that was produced by wireless hand-held units such as a mobile phone from them and printing such data will be discussed. Referring to FIG. 17, a block diagram illustrating a printing apparatus in accordance with the third embodiment is shown. This apparatus includes: a data reception unit 1701; a data enlargement unit 1702; a transformation rule retention unit 1001; a data transformation unit 1703; a jaggy elimination processing unit 1004; and a printing unit 105. The jaggy elimination processing unit 1004 includes a jaggy detection unit 1041 and a vector data production unit 10042.

The data reception unit 1701 receives data in a mobile phone or other hand-held gadget from it. In order to receive such data, radio communications such as using infrared waves is preferable. However, using a cable connection is also feasible.

The data enlargement unit 1702 enlarges the data received by the data reception unit 1701. Regular paper sizes including the letter-size are handled. Since how to enlarge graphical data is publicly well-known, a further description is omitted. The enlargement unit 1702 can typically be formed by using an MPU, a memory, and the like, and all processes assigned thereto are realized by software that is stored in a recording medium such as a ROM. However, hardware implementation (using a dedicated circuit) is also feasible.

The data transformation unit 1703 transforms part of the data enlarged by the data enlargement unit 1702 according to transformation rules in the rule retention unit 1001. The transformation process employed is the same as the one assigned to the data transformation unit 1002. As the data had been enlarged by the enlargement unit 1702, the amount of jaggies has increased. Then that ‘jagged’ data undergoes the processing by the transformation unit 1703 as well as the jaggy elimination processing unit 1004 so as to obtain a smoothed appearance.

Operations of the printing apparatus in the third embodiment will be discussed hereinafter. In accordance with the third embodiment, the printing apparatus is capable of receiving and printing images that were, for example, shot by a camera phone (a mobile phone with a built-in camera). When printing out those images, the data transformation as well as jaggy elimination processing is performed as mentioned above.

First, a user takes a picture with a camera phone, and then sends that data to the printing apparatus. Upon reception of that data, the printing apparatus proceeds to enlarging to a predetermined size such as the letter-size. After that, part of the enlarged data is transformed according to the transformation rules mentioned above, and the jaggy elimination is performed. Thereby, the user can obtain a smoothly-outlined copy of that picture, large yet high quality.

In accordance with the third embodiment, bitmap data received from wireless gadgets such as a camera phone can be enlarged and printed on a paper. When doing so, extremely smoothed and natural images can be realized. Specifically, hand-held gadgets in general produce poor quality (low-resolution) data, and therefore, jagged surfaces stick out by nature when printed by means of an ordinary printing technique. On the other hand, incomparably beautiful appearances can be obtained using the apparatus in the third embodiment.

In the third embodiment, neither the transformation unit nor the rule retention unit is indispensable. This means that the printing apparatus in the third embodiment may only be capable of enlarging data received from a camera phone, eliminating jaggies appearing thereon, and printing it out. Another feasible variation is that the data received from a camera phone is not enlarged, but jaggies appearing thereon are eliminated before printing it out. Moreover, the data enlargement unit is not indispensable either, since the printing apparatus only capable of transforming data from a camera phone according to certain transformation rules, eliminating jaggies, and printing it out is also feasible in the third embodiment.

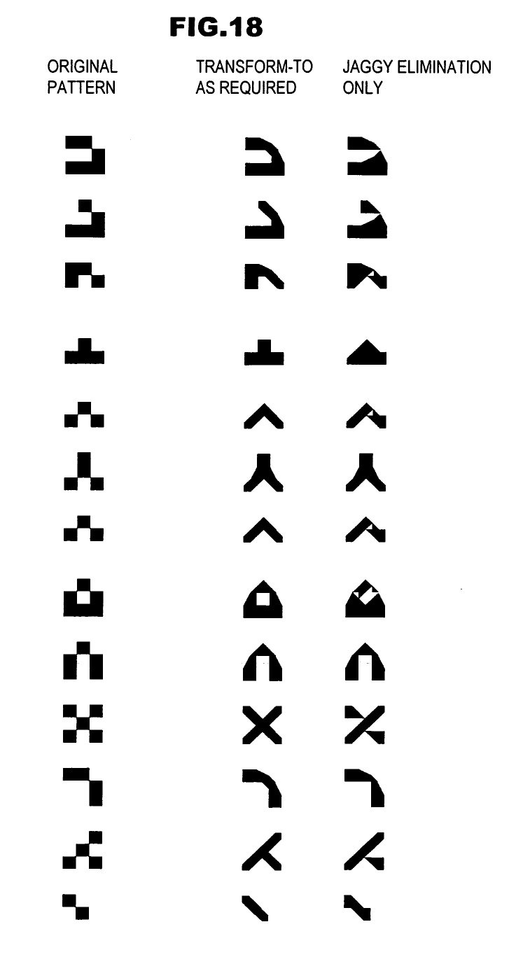

As to the transformation rules, the one shown in FIG. 18 is also applicable. In FIG. 18, rules are managed under the headings “Original Pattern,” “Transform-to as Required,” and “Jaggy Elimination Only.” “Original Pattern” shows dot patterns before transformation. “Transform-to as Required” shows dot patterns after transformation, dot patterns to which original patterns are to be transformed. Contrary to it, “Jaggy Elimination Only” shows data whose jaggies were eliminated from the original dot patterns as set forth in the first and other embodiments, without applying the transformation rules. It should be noted that the kind of transformation rules in FIG. 18 is applicable to the second embodiment.

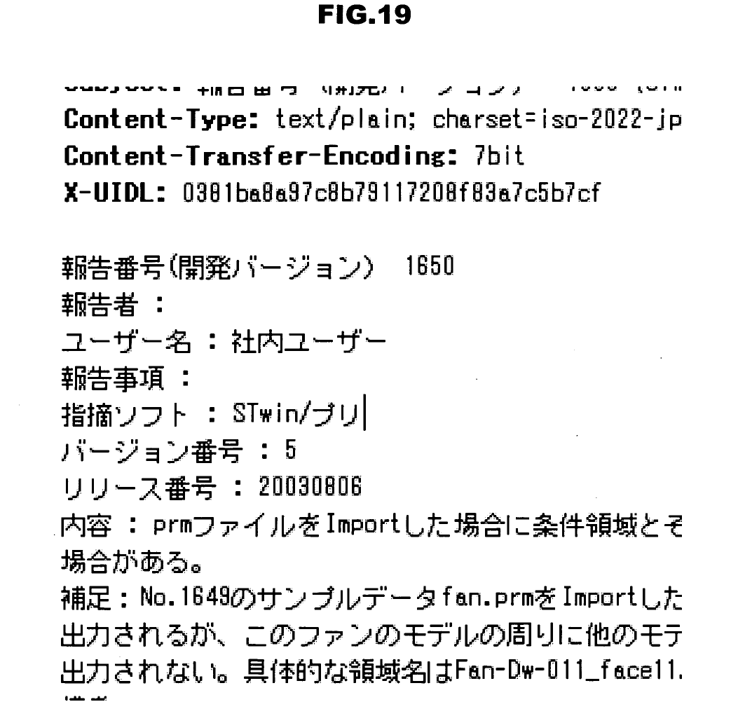

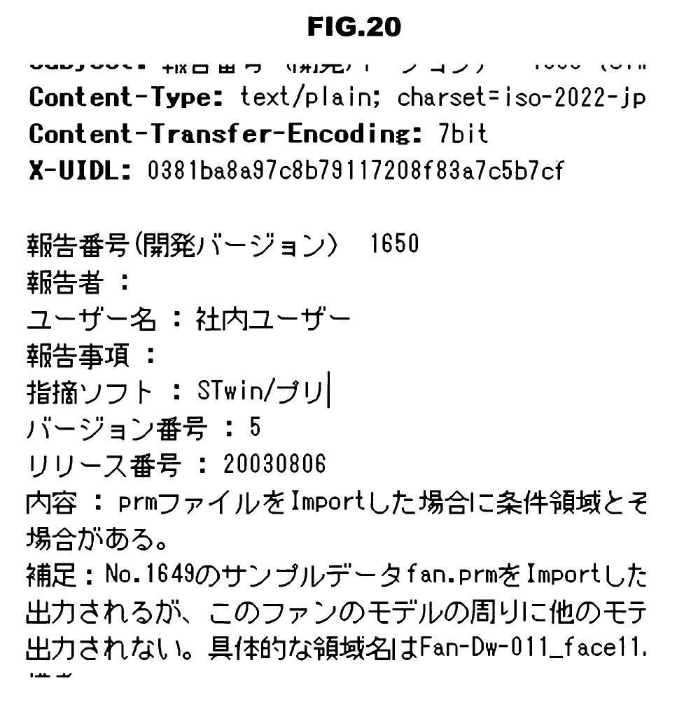

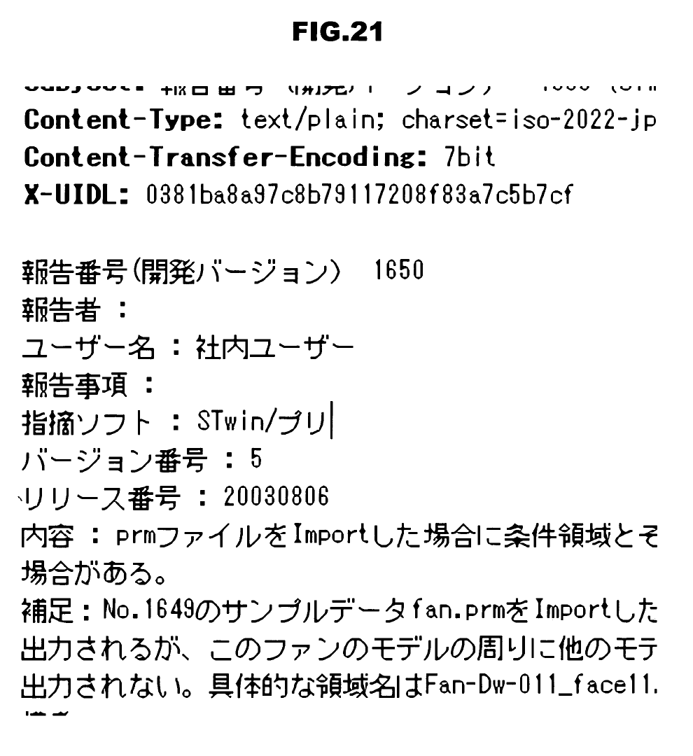

Furthermore, when applying the transformation rules in FIG. 18 to the source data shown in FIG. 19, the resulting data becomes as shown in FIG. 20. Otherwise, the data in FIG. 19 becomes the one shown in FIG. 21.

### INDUSTRIAL APPLICABILITY

Printing apparatuses of the present invention have the effect of eliminating ‘jagged’ artifacts on bitmap data without sacrificing its actual size, and therefore they are useful as a printer capable of printing bitmap data.

What is claimed is:

1. A printing apparatus comprising:
a bitmap data storage unit for storing bitmap data;
a bitmap data acquisition unit for acquiring said bitmap data from said bitmap data storage unit;
a jaggy elimination processing unit for executing processing of eliminating jaggies on said bitmap data; and
a printing unit for printing data that is produced based on processing results from said jaggy elimination processing unit.

2. The printing apparatus according to claim 1, wherein said jaggy elimination processing unit comprises:
a jaggy detection unit for detecting jaggies appearing on said bitmap data; and
a vector data production unit for producing vector data, based on all stair-like straight lines on jaggies that were detected by said jaggy detection unit, by drawing a straight line from a midpoint of one straight line to a midpoint of another straight line adjacent thereto.

3. The printing apparatus according to any one of claims 1 and 2 further comprising:
a transformation rule retention unit for retaining data transformation rules for transforming bitmap data; and
a data transformation unit for transforming part of said bitmap data according to said transformation rules,
said printing unit printing data that is produced based on transformation results from said data transformation unit and processing results from said jaggy elimination processing unit.

4. The printing apparatus according to claim 3, wherein
said transformation rules include 3×3 dot patterns before transformation and 3×3 dot patterns after transformation; and
according to said transformation rules, if a dot pattern on said bitmap data matches any one of said dot patterns before transformation, said pattern is transformed into a corresponding one of said dot patterns after transformation.

5. A computer program that enables a computer to execute the steps of:
acquiring bitmap data stored on the computer;
eliminating jaggies appearing on said bitmap data; and
specifying printing of data that is produced based on processing results obtained in said jaggy elimination step.

6. The computer program according to claim 5 that enables the computer to further execute the step of transforming part of said bitmap data according to transformation rules stored on the computer, and
wherein said step of specifying printing of data that is produced based on processing results obtained in said jaggy elimination step.
